(19) United States
(12) Patent Application Publication
(10) Pub. No.: US 2025/0349945 A1
(43) Pub. Date: Nov. 13, 2025

(54) SECONDARY BATTERY, BATTERY PACK, AND ENERGY STORAGE CONTAINER

(71) Applicant: Jinko Energy Storage Technology Co., Ltd., Haining (CN)

(72) Inventors: Xianrong ZENG, Haining (CN); Yuhao WU, Haining (CN); Yadong LIANG, Haining (CN)

(21) Appl. No.: 18/766,661

(22) Filed: Jul. 9, 2024

(30) Foreign Application Priority Data
May 11, 2024 (CN) 202410583182.3

(51) Int. Cl. H01M 50/103; H01M 50/121; H01M 50/15; H01M 50/16; H01M 50/166; H01M 50/169; H01M 50/176; H01M 50/188; H01M 50/209; H01M 50/251; H01M 50/533; H01M 50/553; H01M 50/567

(52) U.S. Cl. CPC H01M 50/103; H01M 50/121; H01M 50/15; H01M 50/16; H01M 50/166; H01M 50/169; H01M 50/176; H01M 50/188; H01M 50/209; H01M 50/251; H01M 50/533; H01M 50/553; H01M 50/567; H01M 2220/10

(57) ABSTRACT

Secondary battery, battery pack, and energy storage container are provided. Secondary battery includes bare cell, end cover assembly, and cell case. End cover assembly includes cell lid, electrode post, and connecting plate. Cell lid has mounting hole. Electrode post passes through mounting hole and is mounted on cell lid. Connecting plate connects electrode post and bare cell. Cell lid is made of insulating material. Cell is mounted inside cell case. Cell case is made of insulating material. Cell case has recess which is located at boundary position of cell case and recessed in direction adjacent to bare cell. End cover assembly covers cell case. Recess can reduce distance between inner wall of cell case and cell and volume of gap. Recess arranged in cell case reduces volume and capacity of cell case, reduces an amount of an electrolyte solution required to be injected, and reduces processing and manufacturing costs.

### CROSS-REFERENCE TO RELATED APPLICATIONS

The present application claims priority to Chinese Patent Application No. 202410583182.3, filed on May 11, 2024, the content of which is incorporated herein by reference in its entirety.

### TECHNICAL FIELD

The present disclosure relates to the technical field of energy storage, and in particular to a secondary battery, a battery pack, and an energy storage container.

### BACKGROUND

A battery is an apparatus configured to store electrical energy. A positive separator and a negative separator of the battery are soaked in an electrolyte solution. During operation of the battery, the electrolyte solution, as a medium for ion transport, is an important part of the battery, a cell (bare cell) is typically arranged inside a cell case of the battery, and the electrolyte solution is injected into the cell case of the battery to soak the bare cell, so that the cell can operate normally. During manufacturing of the battery, the electrolyte solution may also account for about 15% to 20% of a cost of the battery. Currently, dimensions of a cell case of a secondary battery are greater than those of the bare cell, and there is a certain gap between an inner wall of the cell case of battery and the bare cell. The secondary battery requires injection of more of the electrolyte solution to fully soak the bare cell, and finally a larger amount of the electrolyte solution is injected, leading to a higher manufacturing cost of the secondary battery.

### SUMMARY

In view of this, the present disclosure provides a secondary battery, a battery pack, and an energy storage container, to help solve the problem of the higher manufacturing cost of the battery in the prior art.

The present disclosure provides a secondary battery, the secondary battery including:
a bare cell;
an end cover assembly, the end cover assembly including a cell lid, an electrode post, and a connecting plate, the cell lid having a mounting hole, the electrode post passing through the mounting hole and being mounted on the cell lid, the connecting plate connecting the electrode post and the bare cell, and the cell lid being made of an insulating material; and
a cell case, the cell being mounted inside the cell case, the cell case being made of an insulating material, the cell case having a recess, the recess being located at a boundary position of the cell case, the recess being recessed in a direction adjacent to the bare cell, and the end cover assembly covering the cell case.

The cell case has a cavity configured to mount the bare cell, the cell is arranged inside the cell case, and the cell case has effects of isolation and protection on the bare cell, so that the cell has a suitable operating environment and prevents damages to the bare cell. The cell case is made of an insulating material, the cell case has a recess, the recess is located at a boundary position of the cell case, the recess is recessed in a direction adjacent to the bare cell, and the end cover assembly covers the cell case. The cell case may be in a shape of a polyhedron with an opening such as a square or a rectangle, and the recess is located at a ridge of the cell case. The cell case may be made of an insulating material such as plastic or ceramic, which can reduce a possibility of a short circuit between the cell and the cell case and improve reliability of the cell case. In actual arrangement, the inside of the cell case is filled with an electrolyte solution in addition to the cell mounted. Therefore, a certain gap between the cell and the cell case facilitates mounting of the cell and holding of the electrolyte solution, and at a position of a side wall of the cell case provided with the recess, a distance between an inner wall of the cell case and the cell and a volume of the gap can be reduced. Therefore, the recess arranged in the cell case can reduce a volume and a capacity of the cell case, can reduce an amount of the electrolyte solution required to be injected, and reduce processing and manufacturing costs of the secondary battery. A shape of the recess matches that of the bare cell. For example, if an edge of the cell is in a shape of an arc, the recess may also be set in an arc shape accordingly, so as to reduce a distance between a bottom wall of the recess and the bare cell. In addition, the recess may serve as a reinforcing rib of the cell case, thereby improving mechanical strength of the cell case.

In some embodiments, the cell case has recesses, the recesses are arranged at intervals along a height direction of the secondary battery.

In some embodiments, the cell case has a recessed portion, the recessed portion is located in a side wall of the cell case, and the recessed portion is recessed in a direction adjacent to the bare cell.

In some embodiments, the secondary battery has a length of L and a width of W, where L:W>7.

In some embodiments, secondary battery has a length of L and a height of H, Where H:L>3.

In some embodiments, the insulating material is at least one of polycarbonate, polyamide, polyimide, polyformaldehyde, polyethylene terephthalate, and an acrylonitrile-butadiene-styrene copolymer.

In some embodiments, the cell lid and the cell case are connected by welding, bonding, or hot melting.

In some embodiments, the electrode post includes a main body and a flange, the flange is arranged along a circumferential direction of the main body portion, the flange protrudes along a radial direction of the main body portion, the main body passes through the mounting hole, and the flange abuts against the cell lid and

the end cover assembly includes a sealing member, the sealing member is sleeved on the main body and located between the flange and the cell lid.

The present disclosure provides a battery pack. The battery pack includes a battery module, an upper case cover, and a bottom cover, the battery module is mounted between the upper case cover and the bottom cover, and the battery module includes a plurality of secondary batteries, each of the secondary batteries is the secondary battery in any one of the above embodiments.

The present disclosure provides an energy storage container, wherein the energy storage container includes a cabinet, an inverter, a power management system, and a battery pack, wherein the battery pack is the battery pack in any one of the above embodiments.

### BRIEF DESCRIPTION OF DRAWINGS

In order to more clearly illustrate the technical solutions in embodiments of the present disclosure, the accompanying drawings to be used in the description of the embodiments will be briefly introduced below. Obviously, the accompanying drawings described below are only some embodiments of the present disclosure. For those of ordinary skill in the art, other accompanying drawings can also be obtained from the provided drawings without creative efforts.

FIG. 1 is an exploded view of a secondary battery according to some embodiments of the present disclosure;

FIG. 2 is a schematic structural diagram of the secondary battery according to some embodiments of the present disclosure;

FIG. 3 is a sectional view of an end cover assembly according to some embodiments of the present disclosure;

FIG. 4 is a sectional view of a cell lid according to some embodiments of the present disclosure;

FIG. 5 is a schematic structural diagram of an electrode post according to some embodiments of the present disclosure;

FIG. 6 is an exploded view of a battery pack according to some embodiments of the present disclosure; and

FIG. 7 is a schematic structural diagram of an energy storage container according to some embodiments of the present disclosure.

### REFERENCE SIGNS

1: bare cell;
2: end cover assembly;
   21: cell lid;
      211: mounting hole;
      212: first step groove;
      213: second step groove;
   22: electrode post;
      221: main body;
      222: flange;
      223: limiting groove;
   23: connecting plate;
   24: riveting member;
   25: sealing member;
   3: cell case;
      31: recess;
      32: recessed portion;
   4: battery pack;
      41: battery module;
      42: upper case cover;
      43: bottom cover;
   5: energy storage container.

### DESCRIPTION OF EMBODIMENTS

In order to better understand the technical solution of the present disclosure, embodiments of the present disclosure will be described in detail below with reference to the accompanying drawings.

It should be clear that the described embodiments are only some of rather than all of the embodiments of the present disclosure. Based on the embodiments in the present disclosure, all other embodiments obtained by those of ordinary skill in the art without creative efforts fall within the scope of protection of the present disclosure.

The terms used in the embodiments of the present disclosure are intended only to describe specific embodiments and are not intended to limit the present disclosure. As used in the embodiments of the present disclosure and the appended claims, the singular forms of “a/an”, “one”, and “the” are also intended to include plural forms, unless otherwise clearly specified in the context.

It should be understood that the term “and/or” used herein describes only an association relationship between associated objects and represents that three relationships may exist. For example, A and/or B may represent the following three cases: only A exists, both A and B exist, and only B exists. In addition, the character “/” generally indicates an “or” relationship between the associated objects.

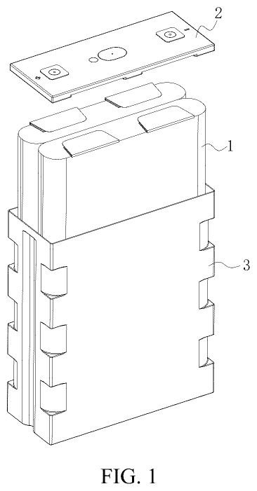

As shown in FIG. 1, some embodiments of the present disclosure provide a secondary battery. The secondary battery includes a cell 1, an end cover assembly 2, and a cell case 3.

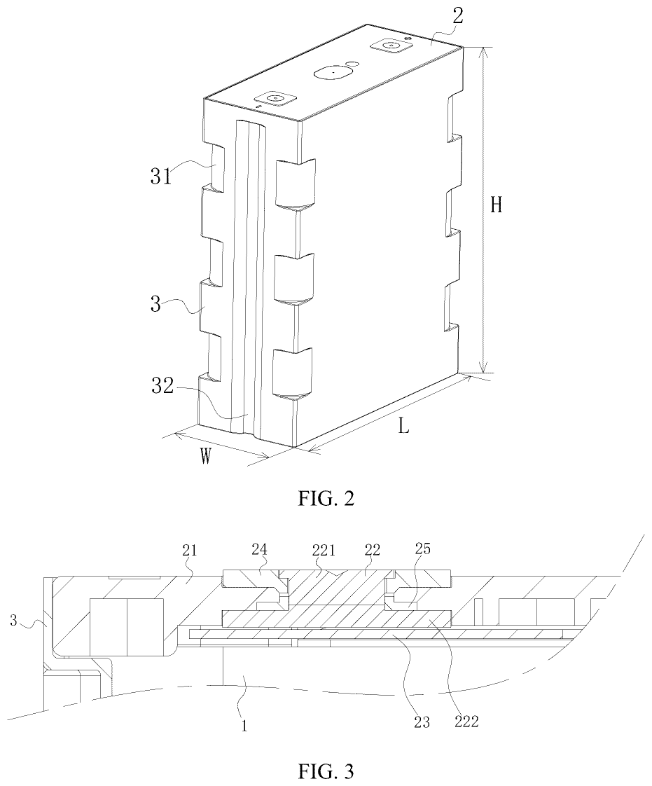

As shown in FIG. 2, the cell case 3 has a cavity configured to mount the cell 1, the cell 1 is arranged inside the cell case 3, and the cell case 3 has effects of isolation and protection on the cell 1, so that the cell 1 has a suitable operating environment and prevents damages to the cell 1. The cell case 3 is made of an insulating material, the cell case 3 has a recess 31, the recess 31 is located at a boundary position of the cell case 3, the boundary position is a position where two adjacent faces of the cell case 3 are connected, the recess 31 is recessed in a direction adjacent to the cell 1, and the end cover assembly 2 covers the cell case 3. The cell case 3 may be in a shape of a polyhedron with an opening such as a square or a rectangle, and the recess 31 is located at a ridge of the cell case 3. The cell case 3 may be made of an insulating material such as plastic or ceramic, which can reduce a possibility of short circuit between the cell 1 and the cell case 3 and improve reliability of the cell case 3.

The cell 1 is required to be connected to an external device through a connection structure such as an electrode post 22 or a connecting plate 23. The use of the insulating material for the cell case 3 can greatly reduce a possibility of a short circuit due to a short circuit between the connection structure and the cell case 3.

In actual arrangement, the cell case 3 is filled with an electrolyte solution in addition to being provided with the cell 1. The electrolyte solution may be used as a medium for ion transport, and the cell 1 is required to be soaked in the electrolyte solution to operate normally. Therefore, a certain gap between the cell 1 and the cell case 3 facilitates mounting of the cell and holding of the electrolyte solution, and at a position of a side wall of the cell case 3 provided with the recess 31, a distance between an inner wall of the cell case 3 and the cell 1 and a volume of the gap can be reduced. Therefore, the recess 31 arranged in the cell case 3 can reduce a volume and a capacity of the cell case 3, the normal operation of the cell 1 requires a certain volume to be soaked in the electrolyte solution, and an amount of the electrolyte solution required to be injected can be reduced when the cell 1 is soaked to a same height, thereby reducing processing and manufacturing costs of the secondary battery. A shape of the recess 31 matches that of the cell 1. For example, if a side wall of the cell 1 has an arc surface, the recess 31 may correspondingly be provided as a recessed structure with an arc surface. For example, the recess 31 includes an arc-shaped side surface recessed in a direction adjacent to the cell 1 and two planar surfaces located at the top and the bottom of the side wall. The two planar surfaces are connected to an outer wall of the cell case 3 respectively, to maintain integrity and sealing performance of the cell case 3. The recess 31 may alternatively be formed by a plurality of planar surfaces connected to each other, or entirely formed by curved surfaces, as long as it is possible to realize the recessing towards the interior of the cell case 3, reduce a distance between a bottom wall of the recess 31 and the cell 1, and reduce a volume of the cell case 3 without affecting the normal operation of the bear cell 1. In addition, the cell case 3 is made of an insulating material. The recess 31 may be made of a same material as the cell case 3 to facilitate processing and manufacturing. The recess 31 may serve as a reinforcing rib of the cell case 3, thereby improving mechanical strength of the cell case 3.

One end of the cell case 3 is provided with an opening. Through the opening, other components such as the cell 1 can be easily mounted inside the cell case 3. The end cover assembly 2 is configured to close the opening of the cell case 3. As shown in FIG. 3, the cell case 3 and the end cover assembly 2 can be connected so that the cell 1 is enclosed and mounted inside the cell case 3, the end cover assembly 2 includes a cell lid 21, an electrode post 22, and a connecting plate 23, the cell lid 21 is connected to the cell case 3, the electrode post 22 has a mounting hole 211, the mounting hole 211 passes through the cell lid 21 along a thickness direction of the end cover assembly 2, at least part of the electrode post 22 protrudes from the mounting hole 211 to the outside of the end cover assembly 2 to facilitate a connection of an external device with the electrode post 22, the connecting plate 23 is arranged on an inner side of the cell lid 21, and the connecting plate 23 connects a tab and the electrode post 22, realizing a function of current conduction. The cell lid 21 is made of an insulating material. For example, the cell lid 21 may be made of a plastic material. The cell lid 21 may directly contact the electrode post 22 without causing a short circuit, which improves overall mounting performance of the secondary battery, eliminates a need for an insulating member, simplifies a structure of the end cover assembly 2, and reduces a processing cost. An edge of the opening of the cell case 3 may be provided with a stepped table, and an edge of the cell lid 21 may lap on a stepped surface on an inner side of the cell case 3 to support the cell lid 21 and facilitate the connection between the cell lid 21 and the cell case 3. The electrode post 22 includes a positive electrode post and a negative electrode post, which are connected to the cell 1 through a positive electrode tab and a negative electrode tab respectively. The connecting plate 23 includes a positive connecting plate and a negative connecting plate, which are respectively configured to connect the positive electrode post with the cell 1 and connect the negative electrode post with the cell 1.

The end cover assembly 2 further includes structures such as an injection hole, an explosion-proof valve, and an identification code. The injection hole is configured to inject the electrolyte solution into the cell case 3, and the injection hole is closed after the injection is completed. The explosion-proof valve is an explosion-proof apparatus of the secondary battery. When the secondary battery accidentally fails and a temperature inside the cell case 3 is extremely high, pressure inside the cell case 3 may increase, and the explosion-proof valve can be opened after a pressure threshold is exceeded, to communicate the inside of the cell case 3 with the outside, exhaust the pressure in time, and prevent explosion of the secondary battery. The cell lid 21 is provided with an exhaust hole to facilitate opening of the exhaust valve for exhaust. The identification code is provided on an outer side of the cell lid 21. The identification code may be a recognizable graphic such as a QR code, which facilitates identification and tracing of the secondary battery.

The cell 1 is a core component for energy storage and functionality of the secondary battery. The cell 1 is typically formed by winding or stacking the positive plate and the negative plate, and a separation film is arranged between the positive plate and the negative plate. The negative plate and the positive plate are each provided with a tab. During charging and discharging of the secondary battery, the positive plate and the negative plate can undergo a corresponding chemical reaction to realize charging and discharging functions, and form a current loop through circuit connections among the tabs, the electrode post 22, and the external device.

The negative plate includes a negative current collector and a negative active material layer with which a surface of the negative current collector is coated. The positive plate includes a positive current collector and a positive active material layer with which a surface of the positive current collector is coated. After winding, the negative active material layer, the positive active material layer, and the separation film therebetween form a winding structure. The negative current collector may be cut to form the negative electrode tab. The positive current collector may be cut to form the positive electrode tab. The positive electrode tab and the negative electrode tab may be located together at one end of the winding structure, or the positive electrode tab and the negative electrode tab may be located at two ends of the winding structure respectively.

The positive electrode tab is electrically connected to the positive electrode post through the positive connecting plate. The negative electrode tab is electrically connected to the negative electrode post through the negative connecting plate. During the charging and discharging of the secondary battery, a positive active material and a negative active material in the winding structure react with the electrolyte solution to generate electrical energy, which is transferred to the positive electrode post through the positive electrode tab and the positive connecting plate and transferred to the negative electrode post through the negative electrode tab and the negative connecting plate, and the electrical energy is outputted through the positive electrode post and the negative electrode post.

Positive electrode posts of a plurality of secondary batteries may be electrically connected through positive connecting plates, and negative electrode posts of the plurality of secondary batteries may be electrically connected through negative connecting plates, to realize series connection, parallel connection, or parallel-series connection of the plurality of secondary batteries.

As shown in FIG. 2, in some embodiments, the cell case 3 has a plurality of recesses 31, and the recesses 31 are arranged at intervals along a height direction of the secondary battery. Through the arrangement of the plurality of recesses 31, the function of reducing the volume of the cell case 3 by the recesses 31 can be improved to achieve an effect of reducing the amount of the electrolyte solution. A single groove 31 reduces an overall volume of the cell case 3 by approximately 1% to 2%, three recesses 31 are respectively provided at four ridges of the cell case 3, and the cell case 3 is provided with a total of twelve recesses 31, which can reduce the overall volume of the cell case 3 by about 20%, thereby reducing the amount of the electrolyte solution by about 20% and reducing the processing cost of the secondary battery. The plurality of recesses 31 are arranged at intervals along ridges of the cell case 3 respectively. The plurality of recesses 31 arranged can maintain an appropriate spacing from the cell 1 inside the cell case 3 without squeezing the cell 1, and the cell 1 can operate normally. Positions of the ridges of the cell case 3 where no recess 31 is provided can still have edges, so that the cell case 3 still has edges and boundarys and an overall shape of the secondary battery can be roughly maintained as a cube or cuboid. When a plurality of secondary batteries are arranged side by side or stacked, adjacent secondary batteries can abut against each other and be positioned by means of the ridges, which facilitates neat arrangement and fixed mounting of the plurality of secondary batteries and reduces a possibility of relative sliding between the plurality of secondary batteries.

As shown in FIG. 2, in some embodiments, the cell case 3 has a recessed portion 32, the recessed portion 32 is located in a side wall of the cell case 3, and the recessed portion 32 is recessed in a direction adjacent to the cell 1.

A bottom wall of the recessed portion 32 may be provided in a form of a curved surface recessed in a direction adjacent to the cell 1, or may be provided in a form where a plurality of planar surfaces with included angles are connected to each other and are recessed in a direction adjacent to the cell 1. The recessed portion 32 extends along the height direction of the secondary battery. Dimensions of the recessed portion 32 may be reasonably set according to an actual requirement. For example, the recessed portion 32 may be arranged in sections along the height direction of the secondary battery, or the recessed portion 32 may extend to the top and the bottom of the cell case 3 along the height direction of the secondary battery. The recessed portion 32 is recessed in the direction adjacent to the cell 1, which can also achieve the effect of reducing the volume of the cell case 3 and reduce the amount of the electrolyte solution required to be injected for the secondary battery, thereby reducing production and manufacturing costs of the secondary battery. The secondary battery may include a plurality of bare cells 1. When the plurality of bare cells 1 are arranged inside a same cell case 3, there may be a gap between adjacent bare cells 1. The arrangement of the recessed portion 32 may reduce a size of the gap and more fully utilize an internal space of the cell case 3.

In some embodiments, a length of the secondary battery is L, a width of the secondary battery is W, and a ratio of the two satisfies L:W>7. For example, the ratio of the two may be 7, 7.5, 8, 8.5, 9, 9.5, 10, 10.5, 11, 11.5, 12, or the like.

In the embodiments of the present disclosure, the cell case 3 and the cell lid 21 are made of insulating materials. Compared with the use of the metal material such as aluminum in the existing solution, the dimensions of the cell case 3 in the embodiments of the present disclosure may be set more flexibly. An aluminum material is generally used in the existing solution. Due to limitations of the aluminum material, a stretched dimension of the aluminum material during processing may be limited by properties of the material, making it impossible to flexibly set the dimensions of the cell case of the battery, that is, the current cell case of the battery is limited by the properties of the material and cannot achieve a large aspect ratio, thereby limiting a volume and a shape of the cell case of the battery. Another insulating material such as plastic is used in the embodiments of the present disclosure, which may be formed by mold molding or injection molding, so that more flexible dimensions can be achieved and the cell case 3 with a larger aspect ratio can be manufactured, thereby manufacturing the secondary battery with a larger aspect ratio. In the embodiments of the present disclosure, the ratio of the length L to the width W of the secondary battery is greater than or equal to 7, so that the overall shape of the secondary battery is a flat shape with a large length and a small width. According to requirements of different actual conditions, the dimensions of the secondary battery can be set more flexibly, and the secondary battery with a larger cell capacity can be manufactured.

In some embodiments, a length of the secondary battery is L, a width of the secondary battery is H, and a ratio of the two satisfies H:L>3. For example, the ratio of the two may be 3, 3.5, 4, 4.5, 5, 5.5, 6, or the like.

Similar to the principle in the above embodiments, the cell case 3 may be provided in a form with a large height and a small length, so that the cell case 3 can be provided in a flat and slender form. The form and the dimensions of the secondary battery can be more flexibly set to adapt to different usage conditions and environments. Length, width, and height dimensions of the secondary battery provided in the embodiments of the present disclosure can be more flexibly set, improving applicability of the secondary battery. Currently, the secondary battery is approximately 174 mm in length, 205 mm in height, and 72 mm in width. The height H, the length L, and the width W of the secondary battery provided in the embodiments of the present disclosure can be more flexibly set. For example, the width W may be set to a value less than the dimension in the current solution, the width W may be 36 mm, the length L may be 252 mm, and the height H may be 756 mm. Only a single cell 1 may be arranged inside the secondary battery, thereby reducing heat generated by the secondary battery and facilitating heat dissipation of the secondary battery. For example, the height H of the secondary battery may be set to a larger dimension, the height H may be 840 mm, the length L may be 280 mm, and the width W may be 40 mm. By setting a larger height dimension H, the volume of the cell case 3 is increased. Further, the cell 1 may also be correspondingly set to a larger dimension, to increase a capacity of the secondary battery and meet more operating environment requirements.

In some embodiments, the insulating material is at least one of polycarbonate, polyamide, polyimide, polyformaldehyde, polyethylene terephthalate, and an acrylonitrile-butadiene-styrene copolymer (ABS plastic).

The cell case 3 and the cell lid 21 are required to protect the cell, and the interior of the cell case 3 is required to hold the electrolyte solution. Both also have to meet a certain degree of corrosion resistance. The temperature rises when the secondary battery is in operation, and the cell case 3 and the cell lid 21 require certain high-temperature resistance. The cell lid 21 and the cell case 3 made of the above materials can meet an operating temperature of the secondary battery, can withstand corrosion of the electrolyte solution, and have certain acid and alkali resistance and corrosion resistance, so that the cell lid 21 and the cell case 3 have good performance and service life. The density of the above materials is relatively low, which helps reduce mass of the secondary battery, is conducive to lightweight of the secondary battery, and is easy to process and shape. The dimensions of the secondary battery can be flexibly set, reducing the processing and manufacturing costs of the secondary battery. The use of the above materials facilitates the processing and shaping of the cell case 3, and the recess 31 and the recessed portion 32 can be relatively easily processed on the surface of the cell case 3, thereby reducing processing difficulty and processing costs. For example, the cell lid 21 and the cell case 3 may be made of polycarbonate (PC). PC has high strength and an elastic coefficient, impact strength, good fatigue resistance, good dimensional stability, a wide operating temperature range, and excellent insulation. The use of the PC material for the cell lid 21 and the cell case 3 can improve overall mounting performance of the secondary battery and facilitate processing and manufacturing of the secondary battery.

In some embodiments, the cell lid 21 and the cell case 3 are connected by welding, bonding, or hot melting.

When the cell lid 21 and the cell case 3 are connected by welding, bonding, or hot melting, the connection is convenient and simple, and no additional connecting members are required, which can simplify a processing procedure and reduce the processing costs. For example, the cell lid 21 and the cell case 3 may be made of plastic and connected by laser welding. By applying pressure to the cell lid 21 and the cell case 3 and then scanning parts by laser, the parts are melted and finally connected together. When the cell lid 21 and the cell case 3 are welded by laser, one should be made of a material with good light transmittance, and the other should be made of a material with strong laser absorption, so that the laser can penetrate the upper material and be absorbed by the lower material, ultimately achieving an effect of welded connection. Laser welding is a non-contact processing manner, which has no vibration, produces no pollution during the processing, and has a clean processing surface, firmly welded seams, and good sealing performance. The bonding connection may be performed by means of a binder, or the hot melt connection may be realized by local heating. A specific method may be reasonably selected according to the materials of the cell lid 21 and the cell case 3.

As shown in FIG. 5, in some embodiments, the end cover assembly 2 includes a riveting member 24, a side wall of the electrode post 22 has a limiting groove 223, and the riveting member 24 sleeves the electrode post 22 and at least partially extends into the limiting groove 223.

The riveting member 24 is arranged at an end of the electrode post 22 that protrudes to the outside relative to the cell lid 21. The riveting member 24 is annular. The riveting member 24 may deform through heating, pressurization, or ultrasonic vibration, so that the riveting member 24 is partially embedded in the limiting groove 223 and partially abuts against the cell lid 21 outside the limiting groove 223. Through riveting connection, the structures of the electrode post 22 and the cell lid 21 are not required to be complexly designed for connection, reducing processing costs. Secondly, the riveting process is simple to assemble, does not require other fasteners, and has high assembly efficiency and strong reliability.

As shown in FIG. 5, in some embodiments, the electrode post 22 includes a main body 221 and a flange 222, the flange 222 is arranged along a circumferential direction of the main body 221, and the flange 222 protrudes along a radial direction of the main body 221. The electrode post 22 is arranged in two parts: a main body 221 and a flange 222, to facilitate mounting and limiting of the electrode post 22. The main body 221 is a main body part of the electrode post 22. The main body 221 may be configured in a cylindrical shape, and the flange 222 is located at one end of the main body 221. Specifically, the flange 222 is located at the end of the main body 221 adjacent to the cell 1. The main body 221 passes through the mounting hole 211, and the flange 222 abuts against the cell lid 21 so as to limit the electrode post 22, so that the electrode post 22 cannot move away from the cell 1, which may further cooperate with the riveting member 24 to fix and mount the electrode post 22 to the cell lid 21.

The end cover assembly 2 includes a sealing member 25. The sealing member 25 sleeves the main body 221 and is located between the flange 222 and the cell lid 21. The sealing member 25 may be made of an elastic material, such as silicone or rubber, to seal a gap between the electrode post 22 and the mounting hole 211, improve sealing performance of the end cover assembly 2, and reduce a possibility of leakage of the electrolyte solution or entry of outside air into the battery.

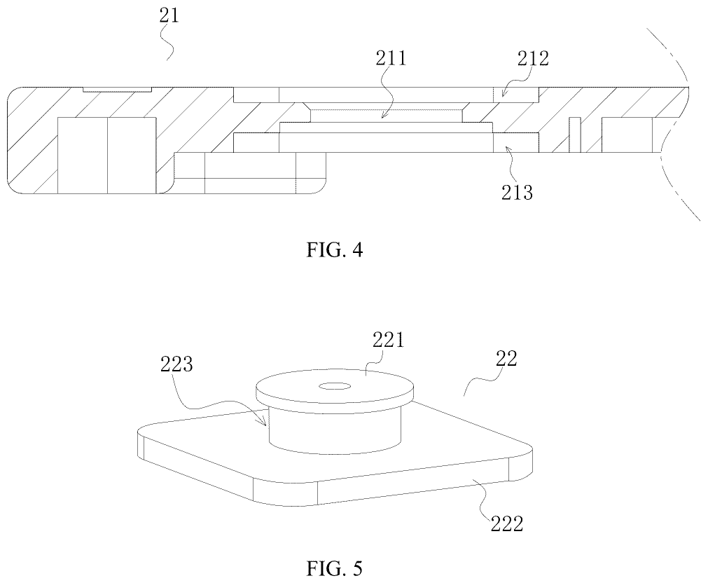

As shown in FIG. 4, in some embodiments, the mounting hole 211 has a first stepped groove 212, the first stepped groove 212 is located at an end of the mounting hole 211 away from the cell 1 and is recessed in the height direction of the secondary battery, and part of the riveting member 24 is mounted in the first stepped groove 212.

A cross-sectional dimension of the riveting member 24 is greater than that of the electrode post 22. When the riveting member 24 is riveted to the electrode post 22, the riveting member 24 and the electrode post 22 are connected to each other, and the riveting member 24 can abut against a bottom wall of the first stepped groove 212, thereby preventing movement of the electrode post 22 in a direction adjacent to the cell 1 and limiting the electrode post 22. The first stepped groove 212 can provide an arrangement space for the riveting member 24. Part of the riveting member 24 is inside the first stepped groove 212 so that the top of the riveting member 24 can be flush with the top of the electrode post 22 or lower than the top of the electrode post 22, which may not affect the connection between the electrode post 22 and the external device.

As shown in FIG. 4, in some embodiments, the mounting hole 211 has a second stepped groove 213, the second stepped groove 213 is located at an end of the mounting hole 211 adjacent to the cell 1, the second stepped groove 213 is recessed in the height direction of the secondary battery, and the flange 222 abuts against the second stepped groove 213. The second stepped groove 213 is configured to mount the flange 222. The flange 222 can abut against a top wall of the second stepped groove 213 to realize a limiting function, and the flange 222 may not protrude towards the interior of the cell case 3 along the height direction of the secondary battery, thereby preventing occupation of the internal space of the cell case 3 and helping increase the capacity of the secondary battery. The flange 222 and the riveting member 24 cooperate with each other and at the same time can limit and fix the electrode post 22. The first stepped groove 212 provides a mounting position for the riveting member 24, and the second stepped groove 213 provides a mounting position for the flange 222, facilitating overall assembly of the end cover assembly 2.

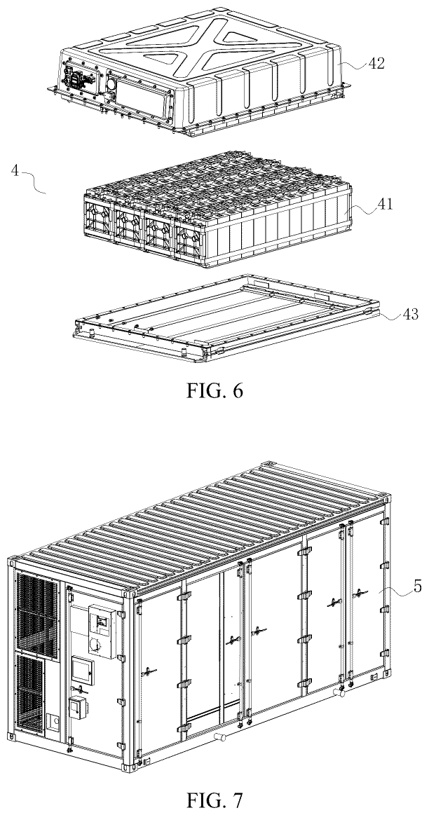

As shown in FIG. 6, some embodiments of the present disclosure provide a battery pack 4. The battery pack 4 includes a box and a plurality of secondary batteries. The plurality of secondary batteries are accommodated in the box. The box may be made of aluminum, aluminum alloy, or other metallic materials, or may alternatively be made of a non-metallic material. The box is configured to provide an accommodation space for the secondary battery. The box may have a variety of structures.

In some embodiments, the box may include a bottom cover 43 and an upper case cover 42, the bottom cover 43 is a structure with the top open, dimensions of the upper case cover 42 are equal to those of a top opening of the bottom cover 43, the upper case cover 42 can cover the bottom cover 43, and the upper case cover 42 and the bottom cover 43 may be connected through a fastener such as a bolt. The upper case cover 42 and the bottom cover 43 define the accommodation space for accommodating the secondary battery. The box may be in various shapes such as a cylinder or a cuboid.

A sealing assembly may also be arranged between the upper case cover 42 and the bottom cover 43 to seal the accommodation space.

In the battery pack 4, the plurality of secondary batteries may be in series connection, parallel connection, or parallel-series connection. The parallel-series connection means that the plurality of secondary batteries are connected in series and in parallel. In some embodiments, the plurality of secondary batteries may be directly connected in series, or in parallel, or in series and in parallel together, and then an entirety formed by the plurality of secondary batteries may be accommodated in the box. The plurality of secondary batteries may be arranged side by side along a length direction of the battery pack 4 or may be arranged side by side along a width direction of the battery pack 4.

In other embodiments, the plurality of secondary batteries may be first connected in series, or in parallel, or in series and in parallel to form battery modules, and then the battery modules are connected in series, or in parallel, or in series and in parallel to form an entirety which is accommodated in the box. The battery module 41 includes a frame structure.

The frame structure may include interconnected end plates, side plates, top plates, and bottom plates. The plurality of secondary batteries are located in an inner cavity of the frame structure and are stacked on each other in the inner cavity of the frame structure. A stacking direction may be a length direction, a width direction, or a height direction.

In addition, the battery pack 4 may further include other structures, such as a bus component, to realize electrical connections between the plurality of secondary batteries.

The secondary battery may be in a shape of a cylinder, a flat body, or a cuboid, or in other shapes.

As shown in FIG. 7, some embodiments of the present disclosure provide an energy storage container 5. The energy storage container 5 includes a cabinet, an inverter, and at least one battery pack 4. The cabinet has an accommodation cavity. The inverter and the battery pack 4 are accommodated in the accommodation cavity. The inverter is configured to convert DC power into AC power. The inverter has advantages of high conversion efficiency, fast startup, high safety, and can also have functions such as short circuit, overload, overvoltage/undervoltage, and over-temperature protection.

Some large energy storage containers 5 may further include a battery management system. The battery management system is configured to make the battery pack 4 operate within a safe operating interval, and may control charging and discharging power of the battery pack 4 according to factors such as an ambient temperature, a battery state, and an electricity demand, to enhance safety of the battery pack 4 and make an operating state of the battery pack 4 more reasonable, thereby helping prolong a battery life and a service life of the battery pack 4.

The structure, features, and effects of the present disclosure are described in detail above according to the embodiments shown in the drawings. The above are only preferred embodiments of the present disclosure, but the present disclosure does not limit the scope of implementation as illustrated in the drawings. Any changes made in accordance with the conception of the present disclosure, or equivalent embodiments modified as equivalent changes, which still do not exceed the spirit covered by the specification and the drawings, shall fall within the protection scope of the present disclosure.

What is claimed is:

1. A secondary battery, comprising:
a cell (1);
an end cover assembly (2) comprising a cell lid (21), an electrode post (22), and a connecting plate (23), wherein the cell lid (21) has a mounting hole (211), the electrode post (22) passes through the mounting hole (211) to be mounted on the cell lid (21), the electrode post (22) and the cell (1) are connected by the connecting plate (23), and the cell lid (21) is made of an insulating material; and
a cell case (3) in which the cell (1) is mounted, wherein the cell case (3) is made of an insulating material, and has a recess (31), the recess (31) is located at a boundary position of the cell case (3), the recess (31) is recessed in a direction adjacent to the cell (1), and the end cover assembly (2) covers the cell case (3).

2. The secondary battery according to claim 1, wherein
the cell case (3) comprises recesses (31) that are arranged at intervals along a height direction of the secondary battery.

3. The secondary battery according to claim 1, wherein
the cell case (3) comprises a recessed portion (32), the recessed portion (32) is located in a side wall of the cell case (3), and the recessed portion (32) recesses in a direction adjacent to the cell (1).

4. The secondary battery according to claim 1, wherein
the secondary battery has a length of L and a width of W, where L:W>7.

5. The secondary battery according to claim 1, wherein
the secondary battery has a length of L and a height of H, where H:L>3.

6. The secondary battery according to claim 1, wherein
the insulating material is at least one of polycarbonate, polyamide, polyimide, polyformaldehyde, polyethylene terephthalate, and an acrylonitrile-butadiene-styrene copolymer.

7. The secondary battery according to claim 1, wherein the cell lid (21) and the cell case (3) are connected by welding, bonding, or hot melting.

8. The secondary battery according to claim 1, wherein
the electrode post (22) comprises a main body (221) and a flange (222), the flange (222) is arranged along a circumferential direction of the main body (221) and protrudes along a radial direction of the main body (221), the main body (221) passes through the mounting hole (221), and the flange (222) abuts against the cell lid (21); and
the end cover assembly (2) comprises a sealing member (25), the sealing member (25) is sleeved on the main body (221) and located between the flange (222) and the cell lid (21).

9. The secondary battery according to claim 1, wherein
the end cover assembly (2) comprises a riveting member (24), a side wall of the electrode post (22) has a limiting groove (223), and the riveting member (24) is sleeved on the electrode post (22) and at least partially extends into the limiting groove (223).

10. A battery pack (4), comprising a battery module (41), an upper case cover (42), and a bottom cover (43), wherein
the battery module (41) is mounted between the upper case cover (42) and the bottom cover (43), and the battery module (41) comprises a plurality of secondary batteries wherein, each of the plurality of secondary batteries comprises:
a cell (1);
an end cover assembly (2) comprising a cell lid (21), an electrode post (22), and a connecting plate (23), wherein the cell lid (21) has a mounting hole (211), the electrode post (22) passes through the mounting hole (211) to be mounted on the cell lid (21), the electrode post (22) and the cell (1) are connected by the connecting plate (23), and the cell lid (21) is made of an insulating material; and
a cell case (3) in which the cell (1) is mounted, wherein the cell case (3) is made of an insulating material, and has a recess (31), the recess (31) is located at a boundary position of the cell case (3), the recess (31) is recessed in a direction adjacent to the cell (1), and the end cover assembly (2) covers the cell case (3).

11. The battery pack according to claim 10, wherein
the cell case (3) comprises recesses (31) that are arranged at intervals along a height direction of the secondary battery.

12. The battery pack according to claim 10, wherein
the cell case (3) comprises a recessed portion (32), the recessed portion (32) is located in a side wall of the cell case (3), and the recessed portion (32) recesses in a direction adjacent to the cell (1).

13. The battery pack according to claim 10, wherein
the secondary battery has a length of L and a width of W, where L:W>7.

14. The battery pack according to claim 10, wherein
the secondary battery has a length of L and a height of H, where H:L>3.

15. The battery pack according to claim 10, wherein
the insulating material is at least one of polycarbonate, polyamide, polyimide, polyformaldehyde, polyethylene terephthalate, and an acrylonitrile-butadiene-styrene copolymer.

16. The battery pack according to claim 10, wherein the cell lid (21) and the cell case (3) are connected by welding, bonding, or hot melting.

17. The secondary battery according to claim 10, wherein
the electrode post (22) comprises a main body (221) and a flange (222), the flange (222) is arranged along a circumferential direction of the main body (221) and protrudes along a radial direction of the main body (221), the main body (221) passes through the mounting hole (221), and the flange (222) abuts against the cell lid (21); and
the end cover assembly (2) comprises a sealing member (25), the sealing member (25) is sleeved on the main body (221) and located between the flange (222) and the cell lid (21).

18. The secondary battery according to claim 10, wherein
the end cover assembly (2) comprises a riveting member (24), a side wall of the electrode post (22) has a limiting groove (223), and the riveting member (24) is sleeved on the electrode post (22) and at least partially extends into the limiting groove (223).

19. An energy storage container, comprising a cabinet, an inverter, a power management system, and a battery pack (4) comprising a battery module (41), an upper case cover (42), and a bottom cover (43), wherein
the battery module (41) is mounted between the upper case cover (42) and the bottom cover (43), and the battery module (41) comprises a plurality of secondary batteries wherein, each of the plurality of secondary batteries comprises:
a cell (1);
an end cover assembly (2) comprising a cell lid (21), an electrode post (22), and a connecting plate (23), wherein the cell lid (21) has a mounting hole (211), the electrode post (22) passes through the mounting hole (211) to be mounted on the cell lid (21), the electrode post (22) and the cell (1) are connected by the connecting plate (23), and the cell lid (21) is made of an insulating material; and
a cell case (3) in which the cell (1) is mounted, wherein the cell case (3) is made of an insulating material, and has a recess (31), the recess (31) is located at a boundary position of the cell case (3), the recess (31) is recessed in a direction adjacent to the cell (1), and the end cover assembly (2) covers the cell case (3).

20. The energy storage container according to claim 19, wherein the cell case (3) comprises recesses (31) that are arranged at intervals along a height direction of the secondary battery.
